(19) United States
(12) Patent Application Publication
(10) Pub. No.: US 2005/0035588 A1
(43) Pub. Date: Feb. 17, 2005

(54) Book reading aid

(76) Inventor: Robert Francis Rickards, Exmouth (GB)

Correspondence Address: Ira S Dorman, 330 Roberts Street, Suite 200, East Hartford, CT, 06108, US

(21) Appl. No.: 10/500,526

(22) PCT Filed: Jan. 6, 2003
(86) PCT No.: PCT/GB03/00009

(30) Foreign Application Priority Data
Jan. 8, 2002 (GB) 0200387.9

(51) Int. Cl. B42D 3/00

(52) U.S. Cl. 281/45

(57) ABSTRACT

A device for facilitating the reading of a book by holding its pages in an open position, includes an elongate member 100 which terminates in two inwardly-directed end-pieces 101 and 102. The end-pieces are pivotally connected to the elongate member 100 with finger and lever portions 30 and 32 disposed on opposite sides of the pivot. Coil springs 203 are provided to urge the finger portions against the pages of the book, and the fingers have straight margins 36 of curved cross-section. The end-pieces thus maintain a substantially constant pressure on the pages irrespective of the number of pages being held. The elongate member 100 includes telescopically-engaged inner and outer elements 108, 107 allowing the spacing between the end-pieces to be adjusted, and a separate platform element 13 is attached to the outer element to support the cover of the book.

### TECHNICAL FIELD OF THE INVENTION

The present invention relates to a device for facilitating the reading of a book.

### BACKGROUND

Books which have simple bindings, particularly paper-back books, do not open flat, especially when new, and tend to close while being read. This is a nuisance because either the book has to be held open when reading or some means have to found to prevent the book from closing. Readers resort to various devices for achieving this end, such as elastic bands, or weights of one sort or another. More sophisticated devices exist such as small lecterns with paper retainers, but these can be inconvenient for personal users. WO 99 12 747 discloses a device which clips to a cover or group of pages of a book and has a page holder which can move vertically on a cylindrical support and be rotated to be brought into juxtaposition with the pages on one side of the spine of the book to retain those pages in position. Although the device may be effective for its purpose, it is cumbersome and could be visually distracting to a reader of a book.

Other simple devices have been proposed, which generally comprise an elongate element for supporting the cover of an open book with in-turned ends to hold the open pages. Examples of such known devices are disclosed in GB 2 055 691 A, GB 2 149 722 A, EP 0 286 545 A2, U.S. Pat. Nos. 5,246,251 and 5,797,631. However, such devices are not capable of firmly holding groups of pages of substantially different thicknesses. Thus, at the start of a book the pages are not adequately held whereas the opposing pages towards the end of the book may be gripped too tightly resulting in a risk of damage as the pages are turned.

It is an object of the present invention to provide an improved device for facilitating the reading of a book which is easy to operate and can firmly hold books of varying sizes without risk of causing damage to the book.

### SUMMARY OF THE INVENTION

According to the present invention, there is provided a device for facilitating the reading of a book by holding its pages in an open position, said device including an elongate member for spanning and supporting the cover of an open book, and two end-pieces directed inwardly towards each other at opposite ends of the elongate member and which include finger portions arranged to press against the pages,
characterised in that the end pieces are formed as separate components which are mounted to move relative to the elongate member.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a general view of a book holder in accordance with the invention;

FIG. 2 is a side view of the book holder being used to hold a book in an open configuration;

FIG. 3 is an end view of the book holder, looking from the left in FIGS. 1 and 2;

FIGS. 4 and 5 are top and bottom views of the book holder, respectively; and

FIGS. 6 and 7 are end details of the book holder showing how the holder is equally effective for holding thin and thick stacks of pages, respectively.

### DETAILED DESCRIPTION OF THE DRAWINGS

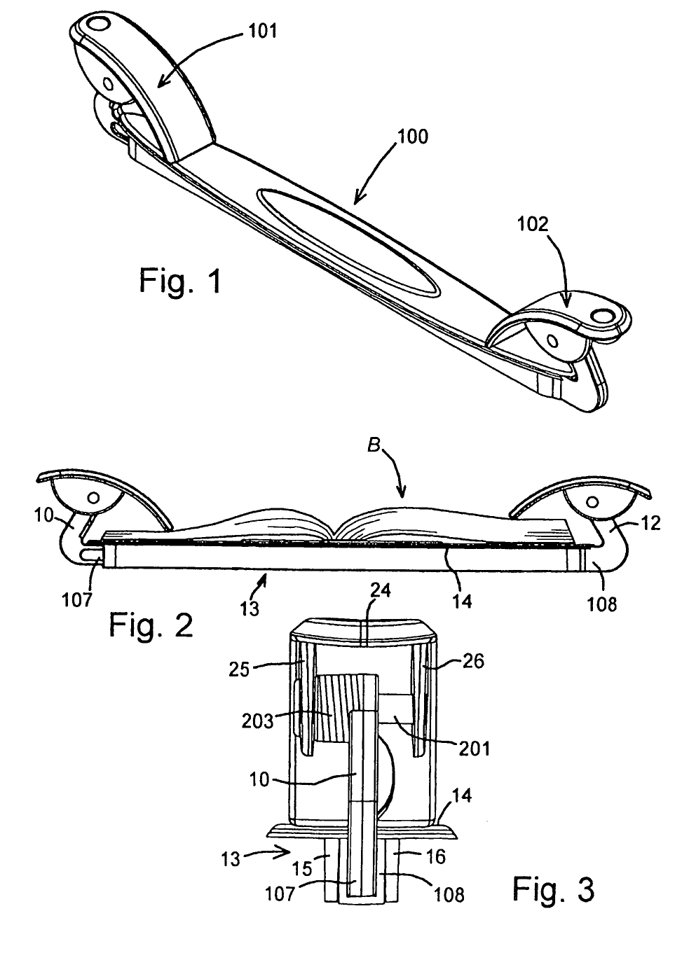

Referring firstly to FIG. 1 of the drawings, the book page holder has an elongated member 100 which terminates in curved end-pieces 101, 102 which are inwardly-directed towards each other to bear upon the open pages of a book.

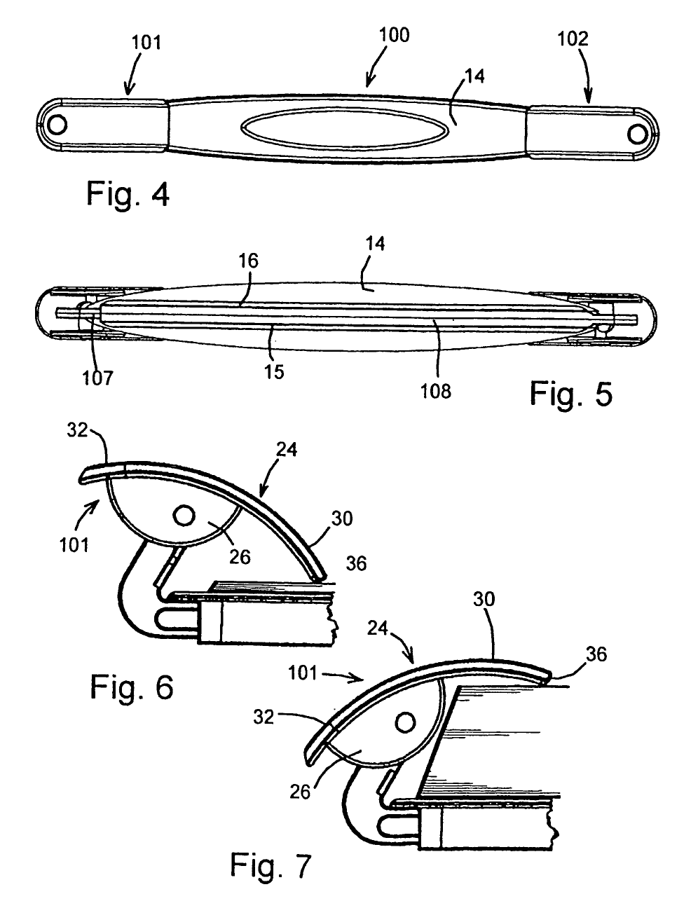

The elongate member 100 is substantially straight with upstanding arms 10 and 12 at opposite ends (FIG. 2), which are angularly inclined towards each other. The elongate member has a tubular outer section 108 of generally rectangular cross-section with an inner section 107 which can be moved telescopically within the outer section so that the distance between the arms 10 and 12 can be continuously varied for use with books of different sizes. The elongate member 100 also includes a third component 13 which includes a platform 14 of substantially elliptical outline (FIG. 4) projecting on opposite sides of the telescopic sections 107 and 108. The component 13 is secured to the telescopically-engaged sections by means of depending walls 15 and 16 (see FIGS. 3 and 5) which clip over the outer section 108.

Referring to FIGS. 6 and 7, each of the end-pieces 101 and 102 is made of a substantially rigid material and has a curved part 24 in the shape of a planar strip which has been arcuately curved in one dimension. Spaced flanges 25 and 26 (FIG. 3) depend from the underside of the curved part 24 on opposite sides of the respective arm 10, 12 to which the flanges are pivotally secured by means of a pivot pin 201. One end of the curved part 24 forms an inwardly-directed finger portion 30 while the opposite end projects on the opposite side of the pivot pin 201 forming a lever portion 32. A coil spring 203 is carried on each of the pins 201 with one end bearing against end-piece 101, 102 and the other end bearing against the respective arm 10, 12 so that the end piece is biassed towards a closed position with an end 36 of the finger portion 30 bearing against the platform 14 of the elongate member 100, as shown. The end 36 of each finger portion is substantially straight in a direction which extends substantially parallel to the axis of the pivot pin 201, but when the end-pieces are viewed in side elevation as in FIGS. 2, 6 and 7 it can be seen that the end 36 is formed with a smooth curve.

When the device is used to hold the pages of an open book B as shown in FIG. 2 the cover of the book is firmly supported by the platform 14 while the springs 203 firmly press the ends 36 of the fingers 30 against the open pages. By using a coil spring, the force applied to the pages is substantially constant irrespective of the number of pages being held. Furthermore, the fingers always apply the same surface area to the pages whether the number of pages is small as in FIG. 6 or large as in FIG. 7, so that the pages will always be held firmly without risk of damage.

When it is desired to release the pages, e.g. to turn a page, the lever portions of one or both of the end-pieces can be pressed downwards causing the finger portions to pivot away from the pages thereby releasing their grip.

The device is thus capable of holding a wide range of books of different sizes without risk of damage. Furthermore, the device is inexpensive to manufacture and easy to operate, even by people suffering from arthritis for example.

It will be appreciated that the features disclosed herein may be present in any feasible combination. Whilst the above description lays emphasis on those areas which, in combination, are believed to be new, protection is claimed for any inventive combination of the features disclosed herein.

1. A device for facilitating the reading of a book by holding its pages in an open position, said device Including an elongate member for spanning and supporting the cover of an open book, wherein the elongate member has arms projecting from opposite ends, and end-pieces formed as separate components have pivotal connections with the arms whereby the end pieces are mounted to move pivotally relative to the elongate member, and the end-pieces include finger portions directed inwardly towards each other at opposite ends of the elongate member and lever portions projecting outwardly to the opposite side of the respective pivotal connection, wherein the finger and lever portions together are generally in the shape of a plane which has been curved in one dimension, and each of said end-pieces is provided with a respective spring element having an end which bears against the end-piece to urge the respective finger portion towards the elongate member to press against the pages of the open book,
characterised in that
the arms are angularly disposed with respect to the elongate member, projecting inwardly, each spring element has an end which bears against the respective arm, and the finger and lever portions are in the form of a curved strip which extends towards the opposite end-piece.

2. A device according to claim 1 wherein each end-piece includes a pair of spaced walls and each spring element is in the form of a coil spring mounted on a pivot pin extending between said pair of spaced walls to pivotally secure the end-piece to the respective arm.

3. A device according to claim 1, wherein an end of each finger portion has a substantially straight margin which extends substantially parallel to the axis of said pivotal connection for contact with the pages.

4. A device according to claim 3, wherein said end of the finger portion is arcuately curved in a plane which is normal to its length.

5. A device according to claim 1, wherein the elongate member includes inner and outer telescopically-engaged elements whereby the distance between the end-pieces can be adjusted.

6. A device according to claim 5, wherein the elongate member includes a platform which projects on opposite sides of said telescopically-engaged elements to support the cover of an open book.

7. A device according to claim 6, wherein said platform is provided by a platform element and an underside of the platform is provided with means for engagement with said outer telescopically-engaged element.
